(19) United States
(12) Patent Application Publication
(10) Pub. No.: US 2026/0179564 A1
(43) Pub. Date: Jun. 25, 2026

(54) DISPLAY DRIVING CIRCUIT AND DISPLAY DRIVING METHOD FOR DISPLAY PANEL AND DISPLAY APPARATUS

(71) Applicants: Chengdu BOE Optoelectronics Technology Co., Ltd., Chengdu, Sichuan (CN); BOE Technology Group Co., Ltd., Beijing (CN)

(72) Inventors: Yao HU, Beijing (CN); Linqian HAN, Beijing (CN)

(73) Assignees: Chengdu BOE Optoelectronics Technology Co., Ltd., Chengdu, Sichuan (CN); BOE Technology Group Co., Ltd., Beijing (CN)

(21) Appl. No.: 18/835,067

(22) PCT Filed: Oct. 25, 2023
(86) PCT No.: PCT/CN2023/126460

§ 371 Date: Aug. 1, 2024

(51) Int. Cl. G09G 3/3266; G09G 3/20; G09G 3/32; G09G 3/36

(52) U.S. Cl. CPC G09G 3/3266; G09G 3/20; G09G 3/32; G09G 3/3677

(57) ABSTRACT

In a display driving circuit, a plurality of cascaded scan driving units in a scan driving circuit are coupled with a clock signal line and an opening signal line respectively, and transmit a scan driving signal to pixels based on signals provided by the coupled signal lines; a plurality of cascaded light-emitting driving units in a light-emitting driving circuit are coupled with the clock signal line and the opening signal line respectively, and transmit a light-emitting control signal to the pixels based on the signals provided by the coupled signal lines; and a plurality of cascaded reset driving units in a reset driving circuit are coupled with the clock signal line and the opening signal line respectively, and transmit a reset control signal to the pixels based on the signals provided by the coupled signal lines so as to drive the pixels to emit light.

### CROSS-REFERENCE TO RELATED APPLICATION

This application is a US national stage of international application No. PCT/CN 2023/126460, filed on Oct. 25, 2023, and the disclosure of which is incorporated herein by reference in its entirety.

### TECHNICAL FIELD

The present disclosure relates to the field of display technologies, and more particularly, to a display driving circuit and a display driving method of a display panel, and a display apparatus.

### BACKGROUND OF THE INVENTION

A display apparatus generally includes a display panel and a display driving circuit, where the display panel includes a substrate and a plurality of pixels located on the substrate. The display driving circuit is coupled with the plurality of pixels and configured to drive the plurality of pixels to emit light.

In related technologies, the display driving circuit is generally disposed on the substrate of the display panel by using a gate-drive-on-array (GOA) technology. Correspondingly, the display driving circuit is also referred to as a GOA circuit. In addition, based on a current pixel structure, the display apparatus generally includes a plurality of GOA circuits that provide different signals (e.g., a scan driving circuit and a light-emitting control circuit). Each GOA circuit is coupled with a plurality of driving signal lines and a plurality of pixels respectively, and is transmit required signals to the plurality of pixels based on driving signals provided by the plurality of driving signal lines to drive the plurality of pixels to emit light.

As a result, the GOA circuit needs to occupy a large area of a display panel, which is not conducive to a narrow border design.

### SUMMARY OF THE INVENTION

An embodiment of the present disclosure provides a display driving circuit and a display driving method of a display panel, and a display apparatus. The technical solutions are summarized as follows.

In an aspect, a display driving circuit is provided, which is applied to a display panel, the display panel including a plurality of pixels; the display driving circuit including:
a scan driving circuit, including a plurality of cascaded scan driving units which are coupled with a clock signal line, an opening signal line as well as the plurality of pixels respectively, and are configured to transmit a scan driving signal to the plurality of pixels in response to a clock signal provided by the coupled clock signal line and an opening signal provided by the coupled opening signal line;
a light-emitting driving circuit, including a plurality of cascaded light-emitting driving units which are coupled with a clock signal line, an opening signal line as well as the plurality of pixels respectively, and are configured to transmit a light-emitting control signal to the plurality of pixels in response to a clock signal provided by the coupled clock signal line and an opening signal provided by the coupled opening signal line; and
a reset driving circuit, including a plurality of cascaded reset driving units which are coupled with a clock signal line and an opening signal line as well as the plurality of pixels respectively, and are configured to transmit a reset driving signal to the plurality of pixels in response to a clock signal provided by the coupled clock signal line and an opening signal provided by the coupled opening signal line, wherein
the clock signal line coupled with the plurality of scan driving units, the clock signal line coupled with the plurality of light-emitting driving units and the clock signal line coupled with the plurality of reset driving units are shared; and the opening signal line coupled with the plurality of scan driving units, the opening signal line coupled with the plurality of light-emitting driving units and the opening signal line coupled with the plurality of reset driving units are independent of each other.

Optionally, at least one driving unit among the scan driving units, the light-emitting driving units and the reset driving units includes:
a first gate circuit, which is respectively coupled with the opening signal line, the clock signal line, a first power line, a second power line and an output node, and is configured to control on-off of the first power line with the output node and control on-off of the second power line with the output node in response to the clock signal and the opening signal; and
a second gate circuit, which is respectively coupled with the output node, the first power line, the second power line and an output end, and is configured to control on-off of the first power line with the output end and control on-off of the second power line with the output end in response to a potential of the output node, and
where output ends of the plurality of scan driving units are coupled with the plurality of pixels through a plurality of scan lines, output ends of the plurality of light-emitting driving units are coupled with the plurality of pixels through a plurality of light-emitting control lines, and output ends of the plurality of reset driving units are coupled with the plurality of pixels through a plurality of reset control lines.

Optionally, the output node includes a first output node and a second output node; and the first gate circuit includes:
a first portion, which is respectively coupled with the opening signal line, the first power line, the second power line and an input node, and is configured to control on-off of the first power line with the input node and control on-off of the second power line with the input node in response to the opening signal, so as to transmit an inversed opening signal, which is obtained by an inverse processing of the opening signal, to the input node; and
a second portion, which is respectively coupled with the opening signal line, the clock signal line, the first power line, the second power line, the input node, the first output node and the second output node, and is configured to control on-off of the first power line with the first output node and control on-off of the second power line with the first output node in response to the opening signal and the clock signal; and control on-off of the first power line with the second output node and control on-off of the second power line with the second output node in response to the inversed opening signal and the clock signal.

Optionally, the at least one driving unit further includes:
a third gate circuit, which is connected in series between a target signal line and the second portion, also respectively coupled with the first power line and the second power line, and is configured to control on-off of the first power line with the second portion and control on-off of the second power line with the second portion in response to a target signal provided by the target signal line, and
where the target signal line includes at least one of the clock signal line and the opening signal line.

Optionally, the target signal line includes the clock signal line and the opening signal line.

Optionally, the third gate circuit includes at least one first logic gate, and where a control end of the at least one first logic gate is coupled with the target signal line, input ends of the at least one first logic gate are coupled with the first power line and the second power line respectively, and an output end of the at least one first logic gate is coupled with the second portion.

Optionally, the at least one first logic gate includes a transmission gate.

Optionally, the at least one first logic gate includes an even number of first NOT gates which are connected in series.

Optionally, the at least one first logic gate includes two first NOT gates which are connected in series.

Optionally, the first portion in the first gate circuit includes a second logic gate; the second portion in the first gate circuit includes a third logic gate and a fourth logic gate; the second gate circuit includes a fifth logic gate and a sixth logic gate;
a control end of the second logic gate is coupled with the opening signal line, input ends of the second logic gate are coupled with the first power line and the second power line respectively, and an output end of the second logic gate is coupled with the input node;
control ends of the third logic gate are coupled with the opening signal line and the clock signal line respectively, input ends of the third logic gate are coupled with the first power line and the second power line respectively, and an output end of the third logic gate is coupled with the first output node;
control ends of the fourth logic gate are coupled with the clock signal line and the input node respectively, input ends of the fourth logic gate are coupled with the first power line and the second power line respectively, and an output end of the fourth logic gate is coupled with the second output node;
control ends of the fifth logic gate are coupled with the first output node and an output end of the sixth logic gate respectively, and input ends of the fifth logic gate are coupled with the first power line and the second power line respectively; and
control ends of the sixth logic gate are coupled with the second output node and an output end of the fifth logic gate respectively, input ends of the sixth logic gate are coupled with the first power line and the second power line respectively, and an output end of the fifth logic gate is coupled with the plurality of pixels as an output end of the second gate circuit.

Optionally, the second logic gate includes a second NOT gate, and each of the third logic gate, the fourth logic gate, the fifth logic gate and the sixth logic gate includes a NAND gate.

Optionally, the logic gate included in at least one gate circuit among the first gate circuit, the second gate circuit and the third gate circuit includes at least one P-type transistor and at least one N-type transistor.

Optionally, a material of the P-type transistor includes a low temperature poly-silicon material; and a material of the N-type transistor includes an oxide material.

Optionally, the display panel further includes a substrate having a display region and a non-display region at least partially surrounding the display region, and the plurality of pixels are located in the display region and arranged in arrays;
the scan driving circuit includes a first scan driving circuit and a second scan driving circuit, and the reset driving circuit includes a first reset driving circuit and a second reset driving circuit;
the opening signal line coupled with the first scan driving circuit and the opening signal line coupled with the second scan driving circuit are independent of each other, and the opening signal line coupled with the first reset driving circuit and the opening signal line coupled with the second reset driving circuit are independent of each other;
a potential of an effective level of a scan driving signal transmitted by a scan driving unit in the first scan driving circuit is opposite to a potential of an effective level of a scan driving signal transmitted by a scan driving unit in the second scan driving circuit; a potential of an effective level of a reset control signal transmitted by a reset driving unit in the first reset driving circuit is opposite to a potential of an effective level of a reset control signal transmitted by a reset driving unit in the second reset driving circuit; and
the display driving circuit are located in the non-display region; and the first scan driving circuit, the second scan driving circuit, the first reset driving circuit, the second reset driving circuit and the light-emitting driving circuit included in the display driving circuit are distributed on both sides of a plurality of rows of pixels in a first direction.

Optionally, a potential of the scan driving signal transmitted by the scan driving unit in the first scan driving circuit is smaller than a potential of the scan driving signal transmitted by the scan driving unit in the second scan driving circuit, and the scan driving circuit includes two first scan driving circuits; and
the two first scan driving circuits, the second scan driving circuit, the first reset driving circuit, the second reset driving circuit and the light-emitting driving circuit are uniformly distributed on both sides in the first direction according to every three as a group.

Optionally, a plurality of cascaded scan driving units included in one of the two first scan driving circuits are located on a first side of the both sides; and a plurality of cascaded scan driving units included in the other first scan driving circuit are located on a second side of the both sides;
a plurality of cascaded scan driving units included in the second scan driving circuit are located on a same side of the both sides, or on the first side and the second side of the both sides, respectively;
a plurality of cascaded reset driving units included in the first reset driving circuit are located on a same side of the both sides, or on the first side and the second side of the both sides, respectively;
a plurality of cascaded reset driving units included in the second reset driving circuit are located on a same side of the both sides, or on the first side and the second side of the both sides, respectively; and
a plurality of cascaded light-emitting driving units included in the light-emitting driving circuit are located on a same side of the both sides, or on the first side and the second side of the both sides, respectively.

Optionally, the plurality of cascaded scan driving units included in the second scan driving circuit are located on a same side of the both sides; the plurality of cascaded reset driving units included in the first reset driving circuit are located on a same side of the both sides; the plurality of cascaded reset driving units included in the second reset driving circuit are located on a same side of the both sides; the plurality of cascaded light-emitting driving units included in the light-emitting driving circuit are located on a same side of the both sides;
the plurality of cascaded reset driving units included in the first reset driving circuit and the plurality of cascaded reset driving units included in the second reset driving circuit are both located on a same side of the both sides;
the plurality of cascaded scan driving units included in the second scan driving circuit and the plurality of cascaded light-emitting driving units included in the light-emitting driving circuit are both located on the second side of the both sides; and
in the first direction and along a direction close to the display region, the second reset driving circuit, the first reset driving circuit and one first scan driving circuit are arranged on the first side in sequence; and the second scan driving circuit, the light-emitting driving circuit and the other first scan driving circuit are arranged on the second side in sequence.

Optionally, the plurality of cascaded scan driving units included in the second scan driving circuit are respectively located on the first side and the second side of the both sides; the plurality of cascaded reset driving units included in the first reset driving circuit are respectively located on the first side and the second side of the both sides; the plurality of cascaded reset driving units included in the second reset driving circuit are respectively located on the first side and the second side of the both sides; the plurality of cascaded light-emitting driving units included in the light-emitting driving circuit are respectively located on the first side and the second side of the both sides;
among the plurality of cascaded scan driving units included in the second scan driving circuit, every two adjacent scan driving units are located on the first side and the second side, respectively;
among the plurality of reset driving units included in the first reset driving circuit, every two adjacent reset driving units are located on the first side and the second side, respectively;
among the plurality of cascaded reset driving units included in the second reset driving circuit, every two adjacent reset driving units are located on the first side and the second side, respectively;
among the plurality of cascaded light-emitting driving units included in the light-emitting driving circuit, every two adjacent light-emitting driving units are located on the first side and the second side, respectively; and
along a second direction of a plurality of columns of pixels, on the first side and the second side, the reset driving units included in the second reset driving circuit and the scan driving units included in the second scan driving circuit are alternately arranged; and the reset driving units included in the first reset driving circuit and the light-emitting driving units included in the light-emitting driving circuit are alternately arranged; and the second direction and the first direction are intersected.

In another aspect, a display driving method is provided, which is applied to the display driving circuit according to the above aspect and configured to drive a display panel to display, wherein the display panel includes a plurality of pixels; and the method includes:
providing an opening signal to an opening signal line, and providing a clock signal to a clock signal line;
transmitting, by a scan driving circuit, a scan driving signal to the plurality of pixels based on the received opening signal and clock signal;
transmitting, by a light-emitting driving circuit, a light-emitting control signal to the plurality of pixels based on received opening signal and clock signal; and
transmitting, by a reset driving circuit, a reset driving signal to the plurality of pixels based on the received opening signal and clock signal, wherein the scan driving signal, the light-emitting control signal and the reset control signal are configured to drive the plurality of pixels to emit light, so that the display panel performs a displaying operation.

In still another aspect, a display apparatus is provided. The display apparatus includes a display panel, and the display driving circuit according to the above aspect, wherein the display driving circuit is coupled with the plurality of pixels in the display panel and configured to drive the plurality of pixels to emit light.

### BRIEF DESCRIPTION OF DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of a display driving circuit according to an embodiment of the present disclosure;

FIG. 2 is a schematic structural diagram of a driving unit in a display driving circuit according to an embodiment of the present disclosure;

FIG. 3 is a schematic structural diagram of a driving unit in another display driving circuit according to an embodiment of the present disclosure;

FIG. 4 is a schematic structural diagram of a driving unit in yet another display driving circuit according to an embodiment of the present disclosure;

FIG. 5 is a circuit structure diagram of a driving unit in a display driving circuit according to an embodiment of the present disclosure;

FIG. 6 is a circuit structure diagram of a driving unit in another display driving circuit according to an embodiment of the present disclosure;

FIG. 7 is a circuit structure diagram of a driving unit in yet another display driving circuit according to an embodiment of the present disclosure;

FIG. 8 is a schematic diagram of signal simulation of the driving unit shown in FIG. 5 according to an embodiment of the present disclosure;

FIG. 9 is a schematic diagram of signal simulation of the driving unit shown in FIG. 6 according to an embodiment of the present disclosure;

FIG. 10 is another schematic diagram of signal simulation of driving unit shown in FIG. 6 according to an embodiment of the present disclosure;

FIG. 11 is a schematic layout diagram of various portions in a display driving circuit according to an embodiment of the present disclosure;

FIG. 12 is a schematic layout diagram of various portions in another display driving circuit according to an embodiment of the present disclosure;

FIG. 13 is a flowchart of a display driving method according to an embodiment of the present disclosure; and

FIG. 14 is a schematic structural diagram of a display apparatus according to an embodiment of the present disclosure.

### DETAILED DESCRIPTION

In order to make the objectives, technical solutions and advantages of the present disclosure clearer, a further detailed description will be made to the embodiments of the present disclosure below with reference to the accompanying drawings.

In a display apparatus, a GOA circuit generally include a plurality of cascaded GOA units, which are coupled (e.g., one-to-one correspondence) with a plurality of rows of pixels to drive the plurality of rows of pixels to emit light. However, in one aspect, as recorded in the background, the arrangement of the GOA circuit is not conducive to a narrow border design of the display apparatus. In another aspect, due to the presence of a capacitor C and a resistor R in the circuit, as well as the effect of coupling between a capacitor and a capacitor, RC Loading (i.e., load) will be changed, and thus an output environment of the GOA units will be changed and affect the output of the GOA units, resulting in the inability to reliably drive the pixels to emit light.

An embodiment of the present disclosure provides a display driving circuit (i.e., a GOA circuit), which can not only facilitate a narrow border design, but also ensure that the output stability is good, so as to reliably drive the pixels to emit light.

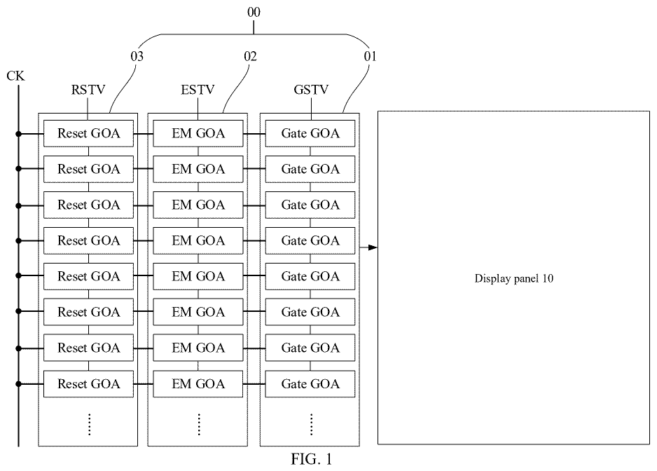

FIG. 1 is a schematic structural diagram of a display driving circuit according to an embodiment of the present disclosure. This display driving circuit may be applied to a display panel 10, which includes a plurality of pixels (not shown). The display driving circuit 00 includes a scan driving circuit 01, a light-emitting driving circuit 02 and a reset driving circuit 03.

The scan driving circuit 01 includes a plurality of cascaded scan driving units Gate GOA. The plurality of cascaded Gate GOAs are coupled with a clock signal line CK and an opening signal line STV respectively, and are also coupled with a plurality of pixels. The plurality of cascaded Gate GOAs are used to transmit a scan driving signal to the plurality of pixels in response to a clock signal provided by the coupled clock signal line CK and an opening signal provided by the coupled opening signal line STV.

The light-emitting driving circuit 02 includes a plurality of cascaded light-emitting driving units EM GOA. The plurality of cascaded EM GOAs are coupled with the clock signal line CK and the opening signal line STV respectively, and are also coupled with the plurality of pixels. The plurality of cascaded EM GOAs are transmit a light-emitting control signal to the plurality of pixels in response to the clock signal provided by the coupled clock signal line CK and the opening signal provided by the coupled opening signal line STV.

The reset driving circuit 03 includes a plurality of cascaded reset driving units Reset GOA. The plurality of cascaded Reset GOAs are coupled with the clock signal line CK and the opening signal line STV respectively, and are also coupled with the plurality of pixels. The plurality of cascaded Reset GOAs are transmit a reset control signal to the plurality of pixels in response to the clock signal provided by the coupled clock signal line CK and the opening signal provided by the coupled opening signal line STV.

Optionally, the plurality of cascaded GOAs included in any driving circuit among the scan driving circuit 01, the light-emitting driving circuit 02 and the reset driving circuit 03 may be coupled with the opening signal line STV through one of the GOAs, may generally be coupled with the opening signal line STV through the first-stage GOA, and may then be cascaded sequentially from the first stage. The opening signal provided by the opening signal line STV may be used to drive the plurality of cascaded GOAs to work. Each stage of the GOA is coupled with the clock signal line CK. The pixels may be configured to emit light in response to the received scan driving signal, light-emitting control signal and reset control signal, such that the display panel performs a displaying operation.

It should be noted that each pixel generally includes a pixel circuit and a light-emitting element that are coupled with each other. Here, all of the plurality of cascaded scan driving units Gate GOA in the scan driving circuit 01, the plurality of cascaded light-emitting driving units EM GOA in the light-emitting driving circuit 02 and the plurality of cascaded reset driving units Reset GOA in the reset driving circuit 03 may be coupled with the pixel circuit in the pixel, and transmit a scan driving signal, a light-emitting control signal and a reset control signal to the pixel circuit respectively. Correspondingly, the pixel circuit may drive the light-emitting element to emit light in response to the received scan driving signal, light-emitting control signal and reset control signal.

With continued reference to FIG. 1, it can be seen that in the embodiment of the present disclosure, the clock signal line CK coupled with the plurality of scan driving units Gate GOA, the clock signal line CK coupled with the plurality of light-emitting driving units EM GOA and the clock signal line CK coupled with the plurality of reset driving units Reset GOA are shared. In addition, the opening signal line STV coupled with the plurality of scan driving units Gate GOA, the opening signal line STV coupled with the plurality of light-emitting driving units EM GOA and the opening signal line STV coupled with the plurality of reset driving units Reset GOA are independent of each other. In order to differentiate, in drawings, the opening signal line STV coupled with the scan driving units Gate GOA is identified as GSTV; the opening signal line STV coupled with the light-emitting driving units EM GOA is identified as ESTV; and the opening signal line STV coupled with the reset driving units Reset GOA is identified as RSTV.

That is, in the embodiment of the present disclosure, only one clock signal line CK may be provided to be coupled with circuits that provide different signals respectively among the display driving circuits; and three opening signal lines STV are respectively provided to be coupled with circuits that provide different signals respectively among the display driving circuits. The circuits that provide different signals include the scan driving circuit 01 that provides the scan driving signal, the light-emitting driving circuit 02 that provides the light-emitting control signal, and the reset driving circuit 03 that provides the reset control signal as described in the above embodiments. In this way, not only the independent and reliable output of different driving circuits can be ensured, but also the number of signal lines that need to be set can be reduced, which is conducive to a narrow border design of the display apparatus.

In summary, an embodiment of the present disclosure provides a display driving circuit. The display driving circuit includes a scan driving circuit, a light-emitting driving circuit and a reset driving circuit. A plurality of cascaded scan driving units in the scan driving circuit are coupled with a clock signal line and an opening signal line respectively, and transmit a scan driving signal to the pixels based on the signal provided by the coupled signal line; a plurality of cascaded light-emitting driving units in the light-emitting driving circuit are coupled with the clock signal line and the opening signal line respectively, and transmit a light-emitting control signal to the pixels based on the signal provided by the coupled signal line; and a plurality of cascaded reset driving units in the reset driving circuit are coupled with the clock signal line and the opening signal line respectively, and transmit a reset control signal to the pixels based on the signal provided by the coupled signal line so as to drive the pixels to emit light. In addition, the scan driving circuit, the light-emitting driving circuit and the reset driving circuit which provide different signals to the pixels share one clock signal line, which may facilitate a narrow border design.

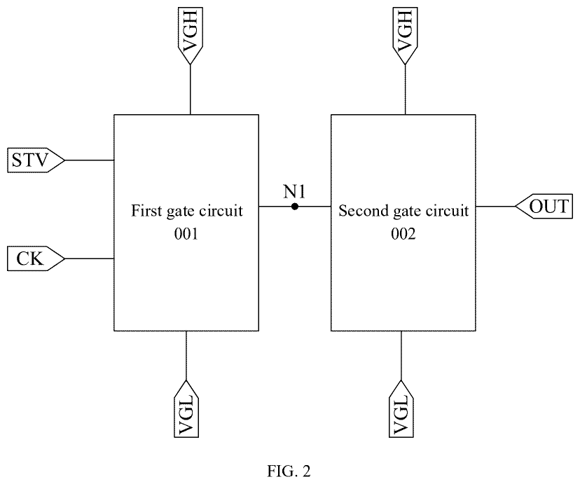

Optionally, referring to FIG. 2, in the embodiment of the present disclosure, at least one driving unit among the scan driving units Gate GOA, the light-emitting driving units EM GOA and the reset driving units Reset GOA may include a first gate circuit 001 and a second gate circuit 002. Exemplarily, FIG. 2 shows that it may be the Gate GOA that includes the first gate circuit 001 and the second gate circuit 002.

The first gate circuit 001 is coupled with the opening signal line STV, the clock signal line CK, a first power line VGH, a second power line VGL and an output node N1 respectively. The first gate circuit 001 is configured to control on-off of the first power line VGH with the output node N1 and control on-off of the second power line VGL with the output node N1 in response to the clock signal and the opening signal.

The second gate circuit 002 is coupled with the output node N1, the first power line VGH, the second power line VGL and an output end OUT respectively. The second gate circuit 002 is configured to control on-off of the first power line VGH with the output end OUT and control on-off of the second power line VGL with the output end OUT in response to a potential of the output node N1.

When the first gate circuit 001 controls the first power line VGH and the output node N1 to be turned on, a first power signal provided by the first power line VGH may be transmitted to the output node N1; and when the first gate circuit 001 controls the second power line VGL and the output node NI to be turned on, a second power signal provided by the second power line VGL may be transmitted to the output node N1.

Similarly, when the second gate circuit 002 controls the first power line VGH and the output end OUT to be turned on, the first power signal provided by the first power line VGH may be transmitted to the output end OUT; and when the second gate circuit 002 controls the second power line VGL and the output end OUT to be turned on, the second power signal provided by the second power line VGL may be transmitted to the output end OUT.

Optionally, a potential of the first power signal provided by the first power line VGH may be a high potential, and a potential of the second power signal provided by the second power line VGL may be a low potential. Here, the high potential and the low potential are relative. On this basis, it can also be seen that the first gate circuit 001 may be configured to control the potential of the output node N1 to be a high potential or low potential in response to the clock signal and the opening signal. The second gate circuit 002 may be configured to output a first power signal with the high potential or a second power signal with the low potential to the output end OUT in response to the potential of the output node N1.

The output ends OUT of the plurality of scan driving units Gate GOA may be coupled with the plurality of pixels via a plurality of scan lines. The output ends OUT of the plurality of light-emitting driving units EM GOA may be coupled with the plurality of pixels via a plurality of light-emitting control lines. The output ends OUT of the plurality of reset driving units Reset GOA may be coupled with the plurality of pixels via a plurality of reset control lines. Here, the coupling may be a one-to-one correspondence coupling. In the embodiment of the present disclosure, the output end OUT is also configured to cascade with the next stage of GOA as an input signal for the next stage of GOA.

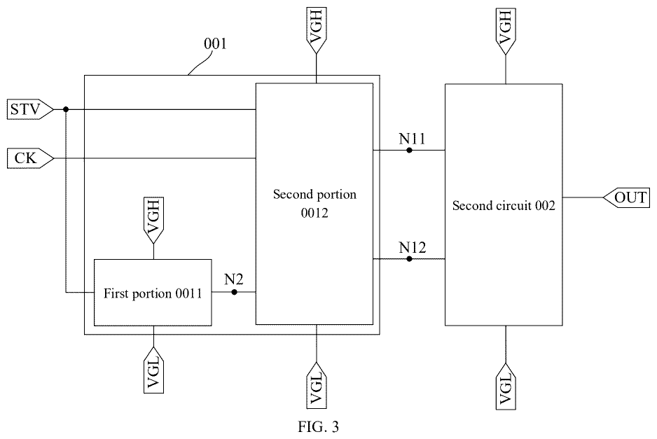

Optionally, based on FIG. 2, with continued reference to a schematic structural diagram of another driving unit shown in FIG. 3, it can be seen that the output node N1 may include a first output node N11 and a second output node N12. The first gate circuit 001 may include a first portion 0011 and a second portion 0012.

The first portion 0011 may be coupled with the opening signal line STV, the first power line VGH, the second power line VGL and the input node N2 respectively. The first portion 0011 is configured to control on-off of the first power line VGH with the input node N2 and control on-off of the second power line VGL with the input node N2 in response to the opening signal, so as to transmit an inversed opening signal, which is obtained by inverse processing of the opening signal, to the input node N2.

Exemplarily, the first portion 0011 may control the first power line VGH and the input node N2 to be uncoupled and control the second power line VGL and the input node N2 to be turned on when the potential of the opening signal is a high potential, so that a second power signal with the low potential provided by the second power line VGL is transmitted to the input node N2. This second power signal with the low potential is the inversed opening signal which is obtained by inverse processing of the high-potential opening signal. Similarly, the first portion 0011 may control the first power line VGH and the input node N2 to be turned on and control the second power line VGL and the input node N2 to be uncoupled when the potential of the opening signal is a low potential, so that a first power signal provided by the first power line VGH with the high potential is transmitted to the input node N2. This first power signal with the high potential is the inversed opening signal which is obtained by inverse processing of the low-potential opening signal. Accordingly, it can be seen that the first portion 0011 is actually equivalent to an inverter.

The second portion 0012 may be coupled with the opening signal line STV, the clock signal line CK, the first power line VGH, the second power line VGL, the input node N2, the first output node N11 and the second output node N12, respectively. The second portion 0012 may be configured to control on-off of the first power line VGH with the first output node N11 and control on-off of the second power line VGL with the first output node N11 in response to the clock signal and the opening signal. The second portion 0012 is configured to control on-off of the first power line VGH with the second output node N12 and control on-off of the second power line VGL with the second output node N12 in response to an inverted opening signal and clock signal.

Exemplarily, in a case that the potential of the opening signal is a high potential, that is, the potential of the inverted opening signal is a low potential, if the potential of the clock signal is a high potential, the second portion 0012 may control the first power line VGH and the first output node N11 to be uncoupled and control the second power line VGL and the first output node N11 to be turned on in response to the high-potential opening signal and the high-potential clock signal, so that the second power signal with the low potential provided by the second power line VGL is transmitted to the first output node N11; and may control the first power line VGH and the second output node N12 to be turned on and control the second power line VGL and the second output node N12 to be uncoupled in response to the low-potential inverted opening signal and the high-potential clock signal, so that the first power signal with the high potential provided by the first power line VGH is transmitted to the second output node N12. If the potential of the clock signal is a low potential, the second portion 0012 may control the first power line VGH and the first output node N11 to be turned on and control the second power line VGL and the first output node N11 to be uncoupled in response to the high-potential opening signal and the low-potential clock signal, so that the first power signal with the high potential provided by the first power line VGL is transmitted to the first output node N11; and may control the first power line VGH and the second output node N12 to be turned on and control the second power line VGL and the second output node N12 to be uncoupled in response to the low-potential inverted opening signal and the low-potential clock signal, so that the first power signal with the high potential provided by the first power line VGH is transmitted to the second output node N12.

Similarly, in a case that the potential of the opening signal is a low potential, that is, the potential of the inverted opening signal is a high potential, if the potential of the clock signal is a high potential, the second portion 0012 may control the first power line VGH and the first output node N11 to be turned on and control the second power line VGL and the first output node N11 to be uncoupled in response to the low-potential opening signal and the high-potential clock signal, so that the first power signal with the high potential provided by the first power line VGH is transmitted to the first output node N11; and may control the first power line VGH and the second output node N12 to be uncoupled and control the second power line VGL and the second output node N12 to be turned on in response to the high-potential inverted opening signal and the high-potential clock signal, so that the second power signal with the low potential provided by the second power line VGL is transmitted to the second output node N12. If the potential of the clock signal is a low potential, the second portion 0012 may control the first power line VGH and the first output node N11 to be turned on and control the second power line VGL and the first output node N11 to be uncoupled in response to the low-potential opening signal and the low-potential clock signal, so that the first power signal with the high potential provided by the first power line VGH is transmitted to the first output node N11; and may control the first power line VGH and the second output node N12 to be turned on and control the second power line VGL and the second output node N12 to be uncoupled in response to the high-potential inverted opening signal and the low-potential clock signal, so that the first power signal with the high potential provided by the first power line VGH is transmitted to the second output node N12.

On this basis, the second gate circuit 002 may control the first power signal with the high potential provided by the first power line VGH to be transmitted to the output end OUT or control the second power signal with the low potential provided by the second power line VGL to be transmitted to the output end OUT in response to the potential of the first output node N11 and the potential of the second output node N12.

With respect to the structure shown in FIG. 3, due to the inevitable existence of a parasitic resistor and a parasitic capacitor on a coupling line of the clock signal line CK/opening signal line STV and the second portion 0012, RC Loading will occur, resulting in poor reliability of the clock signal/opening signal transmitted to the second portion 0012. Then, it is prone to poor reliability and stability of a signal finally transmitted to the output end OUT. For example, a secondary step or glitch may occur to the signal transmitted to the output end OUT. Therefore, the signal transmitted to the output end OUT will eventually be transmitted to the pixels, resulting in poor luminous effect of the pixels and poor displaying effect of the display panel. For example, the display panel has dark lines.

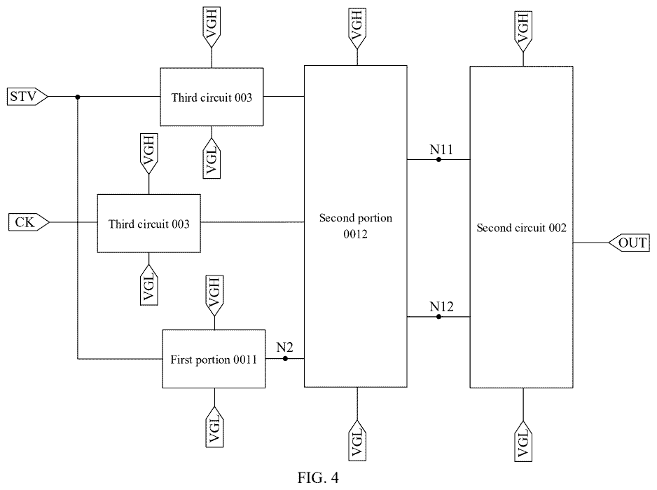

On this basis, referring to a schematic structural diagram of another driving unit shown in FIG. 4, it can be seen that at least one driving unit (the example here is GATE GOA) provided in the embodiment of the present disclosure may also include a third gate circuit 003.

The third gate circuit 003 may be connected in series between a target signal line and the second portion 0012, and may also be coupled with the first power line VGH and the second power line VGL respectively. The third gate circuit 003 may be configured to control on-off of the first power line VGH with the second portion 0012 and control on-off of the second power line VGL with the second portion 0012 in response to a target signal provided by the target signal line.

The target signal line includes at least one of the clock signal line CK and the opening signal line STV. That is, the driving unit may include a third gate circuit 003 connected in series between the clock signal line CK and the second portion 0012. In other words, the clock signal line CK may be indirectly coupled with the second portion 0012 in the first gate circuit 001 via the third gate circuit 003; and/or, the driving unit may include another third gate circuit 003 connected in series between the opening signal line STV and the second portion 0012. In other words, the opening signal line STV may be indirectly coupled with the second portion 0012 in the first gate circuit 001 via the third gate circuit 003.

For example, the driving unit shown in FIG. 4 includes a third gate circuit 003 connected in series between the clock signal line CK and the second portion 0012, and another third gate circuit 003 connected in series between the opening signal line STV and the second portion 0012. That is, the target signal line includes a clock signal line CK and an opening signal line STV. The driving unit includes two third gate circuits 003.

In addition, in the embodiment of the present disclosure, when a potential of the target signal provided by the target signal line is a high potential, the third gate circuit 003 may control the first power line VGH and the second portion 0012 to be turned on and control the second power line VGL and the second portion 0012 to be uncoupled in response to the high-potential target signal, so that the first power signal with the high potential provided by the first power line VGH is transmitted to the second portion 0012. When a potential of the target signal provided by the target signal line is a low potential, the third gate circuit 003 may control the first power line VGH and the second portion 0012 to be uncoupled and control the second power line VGL and the second portion 0012 to be turned on in response to the low-potential target signal, so that the second power signal with the low potential provided by the second power line VGL is transmitted to the second portion 0012. That is, the high-potential target signal provided by the target signal line may be indirectly and synchronously transmitted to the second portion 0012 via the third gate circuit 003.

In other words, if the target signal line is the clock signal line CK, the clock signal provided by the clock signal line CK may be indirectly and synchronously transmitted to the second portion 0012 via the third gate circuit 003, instead of directly transmitted to the second portion 0012 as shown in FIG. 3. If the target signal line is the opening signal line STV, the opening signal provided by the opening signal line STV may be indirectly and synchronously transmitted to the second portion 0012 via the third gate circuit 003, instead of directly transmitted to the second portion 0012 as shown in FIG. 3. In this way, signal glitches can be filtered out through a large first power signal provided by the first power line VGH or a large second power signal provided by the second power line VGL, thereby ensuring better stability of the clock signal/opening signal transmitted to the second portion 0012. Then, good reliability and stability of the signal transmitted to the output end OUT can be ensured. For example, it is possible to make the signal transmitted to the output end OUT smoother and without steps. Further, a good displaying effect can be ensured.

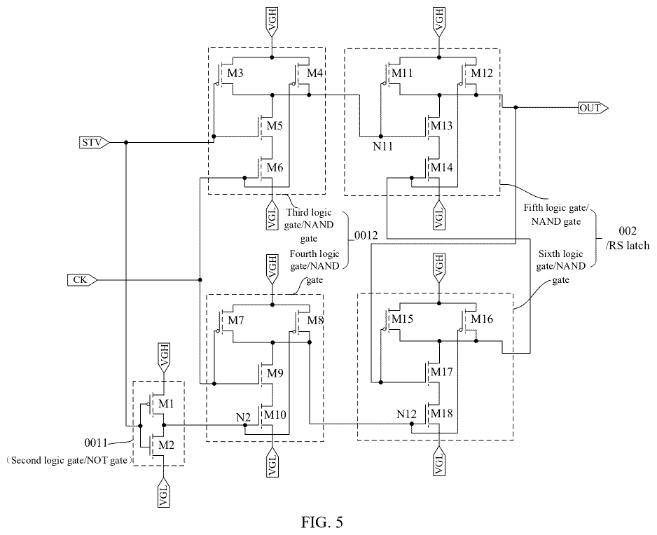

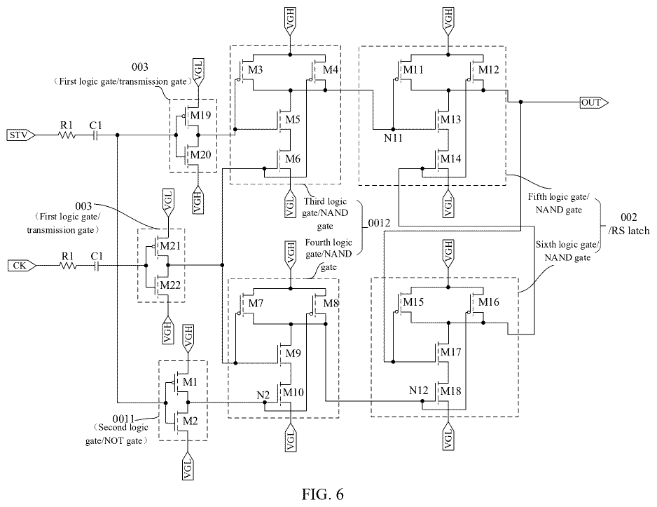

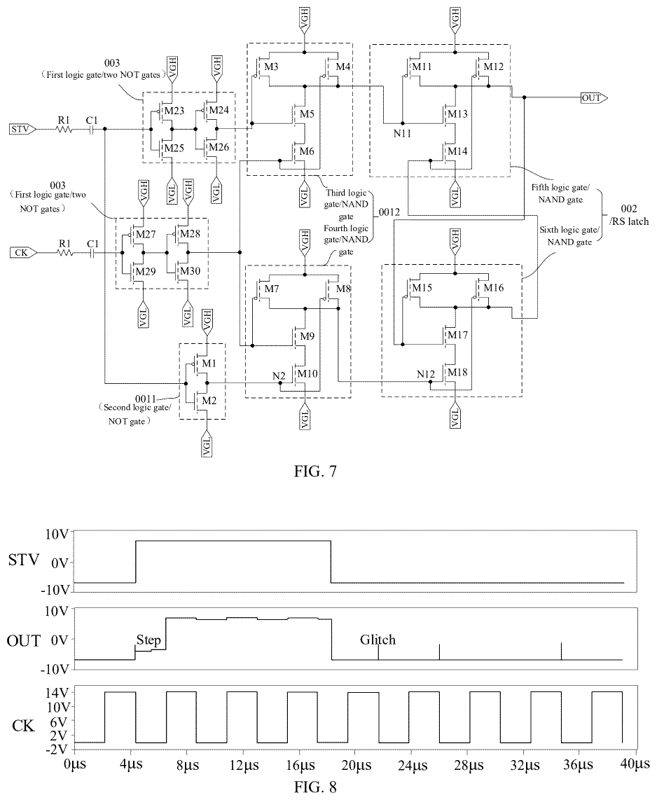

Optionally, based on FIG. 3, FIG. 5 shows a schematic structural diagram of a circuit of a driving unit. Based on FIG. 4, FIG. 6 is a schematic structural diagram of a circuit of another driving unit. FIG. 7 shows a schematic structural diagram of a circuit of yet another driving unit.

Referring to FIGS. 5 to 7, it can be seen that the first portion 0011 in the first gate circuit 001 may include a second logic gate. The second portion 0012 in the first gate circuit 001 may include a third logic gate and a fourth logic gate. The second gate circuit 002 may include a fifth logic gate and a sixth logic gate.

A control end of the second logic gate may be coupled with the opening signal line STV, input ends of the second logic gate may be coupled with the first power line VGH and the second power line VGL respectively, and an output end of the second logic gate may be coupled with the input node N2.

Control ends of the third logic gate may be coupled with the opening signal line STV and the clock signal line CK respectively, input ends of the third logic gate may be coupled with the first power line VGH and the second power line VGL respectively, and an output end of the third logic gate may be coupled with the first output node N11.

Control ends of the fourth logic gate may be coupled with the clock signal line CK and the input node N2 respectively, input ends of the fourth logic gate may be coupled with the first power line VGH and the second power line VGL respectively, and an output end of the fourth logic gate may be coupled with the second output node N12.

Control ends of the fifth logic gate may be coupled with the first output node N11 and an output end of the sixth logic gate respectively, and input ends of the fifth logic gate may be coupled with the first power line VGH and the second power line VGL respectively.

Control ends of the sixth logic gate may be coupled with the second output node N12 and an output end of the fifth logic gate respectively, input ends of the sixth logic gate may be coupled with the first power line VGH and the second power line VGL respectively, and an output end of the fifth logic gate may also be coupled with the plurality of pixels as an output end OUT of the second gate circuit 002.

Exemplarily, as shown in FIGS. 5 to 7, the second logic gate may include a second NOT gate. Each of the third logic gate, the fourth logic gate, the fifth logic gate and the sixth logic gate may include a NAND gate. In addition, based on a coupling mode of the fifth logic gate and the sixth logic gate included in the second gate circuit 002, it can be seen that the second gate circuit 002 is actually an RS latch. In this way, it can also be seen that in the embodiment of the present disclosure, the first gate circuit 001 may actually include one NOT gate and two NAND gates. The second gate circuit 002 may include one RS latch.

Optionally, with continued reference to FIGS. 6 and 7, it can be seen that the third gate circuit 003 may include at least one first logic gate.

A control end of at least one first logic gate may be coupled with target signal lines (including the clock signal line CK and the opening signal line STV), input ends of the at least one first logic gate may be coupled with the first power line VGH and the second power line VGL respectively, and an output end of the at least one first logic gate may be coupled with the second portion 0012.

As an optimal implementation: referring to FIG. 6, the at least one first logic gate includes a transmission gate.

As another optimal implementation: referring to FIG. 7, the at least one first logic gate includes an even number of first NOT gates which are connected in series. For example, the structure shown in FIG. 7 includes two first NOT gates which are connected in series.

That is, FIG. 7 may refer to a changed even-numbered NOT gate structure that takes advantage of the characteristics of the transmission gate shown in FIG. 6. In this way, the Loading effects of the first power signal with the high potential provided by the first power line VGH and the second power signal with the low potential provided by the second power line VGL in the circuit can also be reduced. Specifically, if only one set of signals in the first power signal with the high potentials or second power signal with the low potentials is used, the signal fluctuation of the first power signal with the high potentials or the second power signal with the low potentials will be caused by Loading changes. However, based on a plurality of NOT gates connected in series in an even number of stages, the first power signal with the high potentials and the second power signal with the low potentials can be used at intervals. For example, based on two NOT gates connected in series being included, the first NOT gate outputs a second power signal with the low potential based on the high-potential target signal, and the second NOT gate may output a first power signal with the high potential, and so on alternately. Based on alternate use of the first power signal with the high potentials and the second power signal with the low potentials, a differential mode output can be reduced, while a working state of the circuit is stabilized, resulting in low signal loss.

Optionally, with continued reference to FIGS. 5 to 7, it can be seen that each logic gate included in at least one gate circuit among the first gate circuit 001, the second gate circuit 002 and the third gate circuit 003 may include at least one P-type transistor and at least one N-type transistor.

Any one of the P-type transistor and the N-type transistor may be a metal-oxide-semiconductor (MOS) transistor. The P-type transistor may also be known as a PMOS transistor; and the N-type transistor may also be known as an NMOS transistor. The MOS transistor has a gate electrode, a first electrode, and a second electrode. Combined with descriptions in the above embodiments, the gate electrode may be used as a control end of a logic gate; the first electrode may be used as an input end of the logic gate; and the second electrode may be used as an output end of the logic gate. In the first and second electrodes, one electrode may be referred to as a source electrode and the other electrode may be referred to as a drain electrode. The P-type transistor may be turned on in response to a signal at a low potential received by the gate electrode and may be turned off in response to a signal at a high potential received by the gate electrode. The N-type transistor may be turned on in response to a signal at a high potential received by the gate electrode and may be turned off in response to a signal at a low potential received by the gate electrode.

Exemplarily, referring to FIGS. 5 to 7, a second logic gate that includes a second NOT gate may include one P-type transistor M1 and one N-type transistor M2. A third logic gate that includes a NAND gate may include two P-type transistors M3 and M4 and two N-type transistors M5 and M6. A fourth logic gate that includes a NAND gate may include two P-type transistors M7 and M8 and two N-type transistors M9 and M10. A fifth logic gate that includes a NAND gate may include two P-type transistors M11 and M12 and two N-type transistors M13 and M14. A sixth logic gate that includes a NAND gate may include two P-type transistor M15 and M16 and two N-type transistors M17 and M18. Referring to FIG. 6, on the opening signal line STV, a first logic gate that includes a transmission gate may include one P-type transistor M19 and one N-type transistor M20. On the clock signal line CK, a first logic gate that includes a transmission gate may include one P-type transistor M21 and one N-type transistor M22. Referring to FIG. 7, on the opening signal line STV, a first logic gate that includes two first NOT gates may include two P-type transistors M23 and M24 and two N-type transistors M25 and M26. On the clock signal line CK, a first logic gate that includes two NOT gates may include two P-type transistors M27 and M28 and two N-type transistors M29 and M30.

With respect to a structure shown in FIGS. 5 to 7:
a gate electrode of the P-type transistor M1 and a gate electrode of the N-type transistor M2 may be coupled with the opening signal line STV as control ends of the second logic gate; a first electrode of the P-type transistor M1 and a first electrode of the N-type transistor M2 may be coupled with the first power line VGH and the second power line VGL respectively as input ends of the second logic gate; and a second electrode of the P-type transistor M1 and a second electrode of the N-type transistor M2 may be coupled with the input node N2 as output ends.

A gate electrode of the P-type transistor M11 and a gate electrode of the N-type transistor M13 may be coupled with the first output node N11 as control ends of the fifth logic gate; a gate electrode of the P-type transistor M12 and a gate electrode of the N-type transistor M14 may be coupled with an output end of the sixth logic gate as control ends of the fifth logic gate; a first electrode of the P-type transistor M11 and a first electrode of the P-type transistor M12 may be coupled with the first power line VGH as input ends of the fifth logic gate; a first electrode of the N-type transistor M14 may be coupled with the second power line VGL as an input end of the fifth logic gate; a second electrode of the N-type transistor M14 may be coupled with the first electrode of the N-type transistor M13; and a second electrode of the P-type transistor M11, a second electrode of the P-type transistor M12 and a second electrode of the N-type transistor M13 may be coupled with the pixel as input ends of the fifth logic gate.

A gate electrode of the P-type transistor M15 and a gate electrode of the N-type transistor M17 may be coupled with output ends (i.e., the second electrode of the P-type transistor M11, the second electrode of the P-type transistor M12 and the second electrode of the N-type transistor M13) as control ends of the sixth logic gate; a gate electrode of the P-type transistor M16 and a gate electrode of the N-type transistor M18 may be coupled with the second output node N12 as control ends of the sixth logic gate; a first electrode of the P-type transistor M15 and a first electrode of the P-type transistor M16 may be coupled with the first power line VGH as input ends of the sixth logic gate; a first electrode of the N-type transistor M18 may be coupled with the second power line VGL as an input end of the sixth logic gate; a second electrode of the N-type transistor M18 may also be coupled with the first electrode of the N-type transistor M17; and a second electrode of the P-type transistor M15, a second electrode of the P-type transistor M16 and a second electrode of the N-type transistor M17 may be coupled with control ends (i.e., the gate electrode of the P-type transistor M12 and the gate electrode of the N-type transistor M14) of the fifth logic gate as input ends of the sixth logic gate.

With respect to a structure shown in FIG. 5:
a gate electrode of the P-type transistor M3 and a gate electrode of the N-type transistor M5 may be coupled with the opening signal line STV as control ends of the third logic gate; a gate electrode of the P-type transistor M4 and a gate electrode of the N-type transistor M6 may be coupled with the clock signal line CK as control ends of the third logic gate; a first electrode of the P-type transistor M3 and a first electrode of the P-type transistor M4 may be coupled with the first power line VGH as input ends of the third logic gate; a first electrode of the N-type transistor M6 may be coupled with the second power line VGL as an input end of the third logic gate; a second electrode of the N-type transistor M6 may also be coupled with the first electrode of the N-type transistor M5; and a second electrode of the P-type transistor M3, a second electrode of the P-type transistor M4 and a second electrode of the N-type transistor M5 may be coupled with the first output node N11 as output ends of the third logic gate.

A gate electrode of the P-type transistor M7 and a gate electrode of the N-type transistor M9 may be coupled with the clock signal line CK as control ends of the fourth logic gate; a gate electrode of the P-type transistor M8 and a gate electrode of the N-type transistor M10 may be coupled with the input node N2 as control ends of the fourth logic gate; a first electrode of the P-type transistor M7 and a first electrode of the P-type transistor M8 may be coupled with the first power line VGH as input ends of the fourth logic gate; a first electrode of the N-type transistor M10 may be coupled with the second power line VGL as an input end of the fourth logic gate; a second electrode of the N-type transistor M10 may also be coupled with a first electrode of the N-type transistor M9; and a second electrode of the P-type transistor M7, a second electrode of the P-type transistor M8 and a second electrode of the N-type transistor M9 may be coupled with the second output node N12 as output ends of the fourth logic gate.

With respect to a structure shown in FIG. 6:
a gate electrode of the P-type transistor M19 and a gate electrode of the N-type transistor M20 may be coupled with the opening signal line STV as control ends of the first logic gate; a first electrode of the P-type transistor M19 and a first electrode of the N-type transistor M20 may be coupled with the first power line VGL and the second power line VGH respectively as input ends of the first logic gate; and a second electrode of the P-type transistor M19 and a second electrode of the N-type transistor M20 may be coupled with control ends (i.e., a gate electrode of the P-type transistor M3 and a gate electrode of the N-type transistor M5) as output ends of the first logic gate.

A gate electrode of the P-type transistor M21 and a gate electrode of the N-type transistor M22 may be coupled with the clock signal line CK as control ends of the first logic gate; a first electrode of the P-type transistor M21 and a first electrode of the N-type transistor M22 may be coupled with the second power line VGL and the first power line VGH respectively as input ends of the first logic gate; and a second electrode of the P-type transistor M21 and a second electrode of the N-type transistor M22 may be coupled with control ends (i.e., a gate electrode of the P-type transistor M4 and a gate electrode of the N-type transistor M6) of the third logic gate in the second portion 0012 as output ends of the first logic gate, and coupled with control ends (i.e., a gate electrode of the P-type transistor M7 and a gate electrode of the N-type transistor M9) of the fourth logic gate in the second portion 0012.

With respect to a structure shown in FIG. 7:
a gate electrode of the P-type transistor M23 and a gate electrode of the N-type transistor M25 may be coupled with the opening signal line STV as control ends of the first logic gate; a first electrode of the P-type transistor M23 and a first electrode of the N-type transistor M24 may be coupled with the first power line VGH as input ends of the first logic gate; a first electrode of the N-type transistor M25 and a first electrode of the N-type transistor M26 may be coupled with the second power line VGL as input ends of the first logic gate; both a second electrode of the P-type transistor M23 and a second electrode of the N-type transistor M25 may be coupled with a gate electrode of the P-type transistor M24 and a gate electrode of the N-type transistor M26, respectively; and a second electrode of the P-type transistor M24 and a second electrode of the N-type transistor M26 may be coupled with control ends (i.e., a gate electrode of the P-type transistor M3 and a gate electrode of the N-type transistor M5) of the third logic gate in the second portion 0012 as output ends of the first logic gate.

A gate electrode of the P-type transistor M27 and a gate electrode of the N-type transistor M29 may be coupled with the clock signal line CK as control ends of the first logic gate; a first electrode of the P-type transistor M27 and a first electrode of the N-type transistor M28 may be coupled with the first power line VGH as input ends of the first logic gate; a first electrode of the N-type transistor M29 and a first electrode of the N-type transistor M30 may be coupled with the second power line VGL as input ends of the first logic gate; both a second electrode of the P-type transistor M27 and a second electrode of the N-type transistor M29 may be coupled with a gate electrode of the P-type transistor M28 and a gate electrode of the N-type transistor M30, respectively; a second electrode of the P-type transistor M28 and a second electrode of the N-type transistor M30 may be coupled with control ends (i.e., a gate electrode of the P-type transistor M4 and a gate electrode of the N-type transistor M6) of the third logic gate in the second portion 0012 as output ends of the first logic gate, and coupled with control ends (i.e., a gate electrode of the P-type transistor M7 and a gate electrode of the N-type transistor M9) in the fourth logic gate in the second portion 0012.

Optionally, FIGS. 6 and 7 also schematically show a parasitic resistor R1 and a parasitic capacitor C1 present on the opening signal line STV and the clock signal line CK.

Optionally, a material of the P-type transistor may include a low temperature poly-silicon (LTPS) material. A material of the N-type transistor may include an oxide material. The material of the transistor here refers to a material of an active layer included in the transistor. Since a threshold voltage of an N-type transistor including the oxide material is smaller than that of a P-type transistor including the LTPS material, a turn-on threshold of the transistor can be adjusted by a width-length ratio of the P-type transistor. That is, the transistor including the LTPS material has advantages of high mobility, fast charging and the like, and the transistor including the oxide material has advantages of low leakage current and the like, both of which are integrated on a display panel, that is, an LTPS+Oxide (LTPO) display panel to achieve low-frequency drive by taking advantages of the two transistors and reduce power consumption, thereby improving the display quality.

It should be noted that, as can also be seen in conjunction with FIGS. 5 to 7, the driving unit described in the embodiments of the present disclosure only includes a plurality of transistors, but does not include a capacitor, thereby avoiding the problem of poorer stability of output signals to the output end OUT caused by the coupling between capacitors and can further ensure a better display effect.

A working principle of a NOT gate is as follows: if an input is a high potential (logic 1), an output is a low potential (logic 0); and conversely, if an input is a low potential (logic 0), an output is a high potential (logic 1). A working principle of an NAND gate is as follows: if an input has one or more low potentials, an output is a high potential; and if inputs are all high potentials, an output potential is a low potential. A working principle of a transmission gate is as follows: an output has the same potential as an input. It can be seen that the first gate circuit 001, the second gate circuit 002 and the third gate circuit 003 may be made to achieve the functions described in the above embodiments by adopting a design mode of FIGS. 5 to 7. That is, a working principle of the driving unit described in the embodiments of the present disclosure may be summarized as follows:
under the control of the clock signal provided by the clock signal line CK, the opening signal provided by the opening signal line STV may be transmitted to the output end OUT through four NAND gates (including two NAND gates in the first gate circuit 001 and two NAND gates in the second gate circuit 002). The transmission characteristic of the two NAND gates in the first gate circuit 001 satisfies: a low potential is output as long as a potential of the clock signal is high. The two NAND gates in the second gate circuit 002 form an RS latch, and the transmission characteristic satisfies: an output will not change, that is, it is in a holding state, as long as there is one high potential in an input. It can be correspondingly seen that the transmission characteristic of the whole driving unit can satisfy: if a potential of the clock signal is a high potential, an opening signal will be changed to an output signal, that is, the opening signal may be transmitted to the output end OUT. The potential of the clock signal is negated at the next stage, such that it may complete a shift register function.

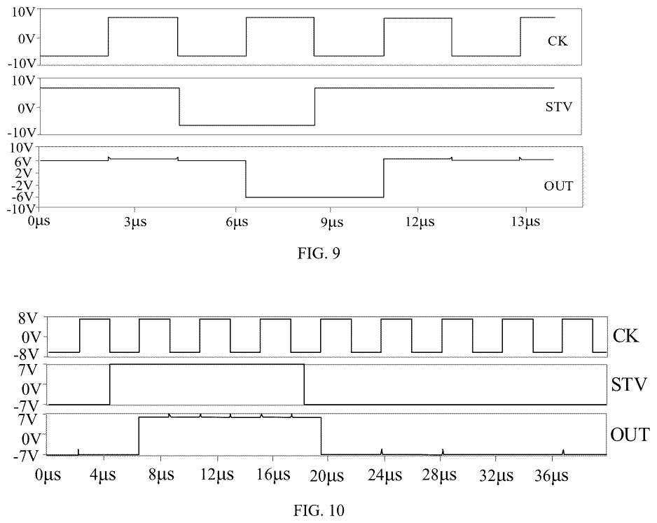

On this basis, taking the structure shown in FIG. 5 as an example, FIG. 8 shows a signal simulation diagram; and taking a structure shown in FIG. 6 as an example, FIG. 9 is another signal simulation diagram and FIG. 10 is yet another signal simulation diagram. The signal simulation diagram shown in FIG. 9 may refer to a driving signal that transmits a low potential as an effective potential to a pixel. The signal simulation diagram shown in FIG. 10 may refer to a driving signal that transmits a high potential as an effective potential to a pixel. In addition, in the signal simulation diagrams shown in FIGS. 8 to 10, the abscissa refers to time in microseconds (μs), and the ordinate refers to a voltage in volts (V).

Referring to FIGS. 8 to 10, it can be seen that the clock signal provided by the clock signal line CK may be a periodically changing pulse signal, and each waveform turn may represent charging time for a row of pixels, which may be in units of 1H. Compared with FIG. 8, it can be further seen from FIG. 9/FIG. 10 that on the basis of not adding the third gate circuit 003, the signal transmitted to the output end OUT has steps and glitches due to the influence of RC Loading, where the glitches are generally half-peaks of an level output. However, on the basis of adding the third gate circuit 003, since the glitches cannot change a state of the transistor in the third gate circuit 003 and can be effectively filtered out, the output stability can be improved, that is, the signal transmitted to the output end OUT has no steps and glitches shown in FIG. 8.

It should be noted that the above design of the circuit structure is only an illustrative description, and any structure that can achieve the circuit function described in the embodiments of the present disclosure is within the protection scope of the embodiment of the present disclosure.

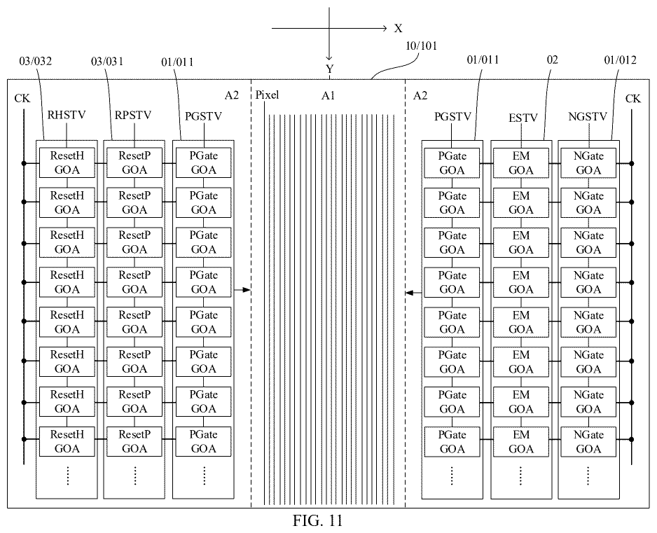

Optionally, FIG. 11 is a schematic structural diagram of a display panel provided by an embodiment of the present disclosure. As shown in FIG. 11, the display panel 10 may also include a substrate 101, where the substrate 101 may have a display region Al and a non-display region A2 that at least partially surrounds the display region. For example, referring to FIG. 11, the shown substrate 101 has a display region A1, as well as non-display regions A2 located on the left and right sides of the display region A1. Of course, this is an illustrative description only. A plurality of pixels may be located in the display region Al and arranged in arrays, i.e., may include a plurality of rows and columns of pixels. The display driving circuit 00 may be located on the non-display regions A2. That is, as described in the above embodiments, the display driving circuit 00 may be integrated on the substrate of the display panel, and may also be referred to as a GOA circuit.

Optionally, with continued reference to FIG. 11, it can be seen that the scan driving circuit 01 may include a first scan driving circuit 011 and a second scan driving circuit 012. The reset driving circuit 03 may include a first reset driving circuit 031 and a second reset driving circuit 032.

The opening signal line STV coupled with the first reset driving circuit 011 and the opening signal line STV coupled with the second reset driving circuit 012 may be independent of each other. The opening signal line STV coupled with the first reset driving circuit 031 and the opening signal line STV coupled with the second reset driving circuit 032 may be independent of each other.

In addition, a potential of an effective level of a scan driving signal transmitted by a scan driving unit Gate GOA in the first scan driving circuit 011 is opposite to a potential of an effective level of a scan driving signal transmitted by a scan driving unit Gate GOA in the second scan driving circuit 012. A potential of an effective level of a reset control signal transmitted by a reset driving unit Reset GOA in the first reset driving circuit 031 is opposite to a potential of an effective level of a reset control signal transmitted by a reset driving unit Reset GOA in the second reset driving circuit 032. Combined with the above embodiments, the potential of the effective level here may refer to an effective potential that controls the transistor to be turned on; and what corresponds to the potential of the effective level is a potential of an ineffective level that controls the transistor to be turned off, that is, an ineffective potential.

Exemplarily, an effective potential of the scan driving signal transmitted by the scan driving unit Gate GOA in the first scan driving circuit 011 may be a low potential; and an effective potential of the scan driving signal transmitted by the scan driving unit Gate GOA in the second scan driving circuit 012 may be a high potential. That is, the effective potential of the scan driving signal transmitted by the scan driving unit Gate GOA in the first scan driving circuit 01 may be less than the effective potential of the scan driving signal transmitted by the scan driving unit Gate GOA in the second scan driving circuit 01. An effective potential of the reset control signal transmitted by the reset driving unit Reset GOA in the first reset driving circuit 031 may be a low potential; and an effective potential of the reset control signal transmitted by the reset driving unit Reset GOA in the second reset driving circuit 032 may be a high potential. That is, the effective potential of the scan driving signal transmitted by the reset driving unit Reset GOA in the first reset driving circuit 031 may be less than the effective potential of the scan driving signal transmitted by the reset driving unit Reset GOA in the second reset driving circuit 032.

For pixels, the pixel circuit generally includes a P-type transistor and an N-type transistor. The P-type transistor is turned on in response to a signal at a low potential received by a gate electrode. The N-type transistor is turned on in response to a signal at a high potential received by the gate electrode. Therefore, the scan driving unit Gate GOA in the first scan driving circuit 011 may also be referred to as PGate GOA, and the scan driving unit Gate GOA in the second scan driving circuit 012 may also be referred to as NGate GOA. Similarly, the reset driving unit Reset GOA in the first reset driving circuit 031 may also be referred to as ResetP GOA, and the reset driving unit Reset GOA in the second reset driving circuit 032 may also be referred to as ResetH GOA. The signal simulation diagram shown in FIG. 9 may refer to a signal simulation diagram corresponding to PGate GOA. The signal simulation diagram shown in FIG. 10 may refer to a signal simulation diagram corresponding to the NGate GOA. In addition, in order to differentiate, the opening signal line coupled with PGate GOA is identified as PGSTV. The opening signal line coupled with NGate GOA is identified as NGSTV. The opening signal line coupled with ResetP GOA is identified as RPSTV. The opening signal line coupled with ResetH GOA is identified as RHSTV.

In the embodiment of the present disclosure, the first scan driving circuit 011, the second scan driving circuit 012, the first reset driving circuit 031, the second reset driving circuit 032 and the light-emitting control circuit 02 can all share one clock signal line CK. On this basis, considering that the design of one clock signal line CK may have the problem of a large load, it is possible to reduce the impedance and parasitic capacitance of a single line by increasing a line width of the clock signal line CK.

In addition, with continued reference to FIG. 11, it can also be seen that the first scan driving circuit 011, the second scan driving circuit 012, the first reset driving circuit 031, the second reset driving circuit 032 and the light-emitting driving circuit 12 included in the display driving circuit 00 may be distributed on both sides of a plurality of rows of pixels in a first direction X. In this way, it is conducive to narrow border designs on both sides. Correspondingly, the first direction X may also refer to a row direction.

Optionally, with continued reference to FIG. 11, it can also be seen that the scan driving circuit 01 may include two first scan driving circuits 011. Because the pixel circuit in the pixel generally includes a large number of P-type transistors, two first scan driving circuits 011 arranged here can ensure a reliable driving of the P-type transistors.

In addition, the two first scan driving circuits 011, the second scan driving circuit 012, the first reset driving circuit 031, the second reset driving circuit 032 and the light-emitting driving circuit 02 are uniformly distributed on both sides in the first direction X according to every three as a group. In this way, a narrow border design on both sides can be further facilitated, so that areas required to be occupied by the non-display regions A2 on both sides are the same as much as possible.

Exemplarily, referring to FIG. 11, in the two first scan driving circuits 011, a plurality of cascaded scan driving units PGate GOA included in one first scan driving circuit 011 may be located on a first side (e.g., a left side in FIG. 11, which will not be repeated in the following embodiments) of both sides. A plurality of cascaded scan driving units PGate GOA included in the other first scan driving circuit 011 may be located on a second side (e.g., a right side in FIG. 11, which will not be repeated in the following embodiments) of both sides. That is, the two first scan driving circuits 011 may be distributed on both sides. In this way, the reliable driving of the display region Al close to the left/right pixel can be ensured, a difference in signals outputted to the pixels at different positions due to the influence of Loading can be avoided, and a better display uniformity can be ensured.

Based on FIG. 11, as an optional implementation:
a plurality of cascaded scan driving units NGate GOA included in the second scan driving circuit 012 may be located on a same side of the both sides; a plurality of cascaded reset driving units ResetP GOA included in the first reset driving circuit 031 may be located on a same side of the both sides; a plurality of cascaded reset driving units ResetH GOA included in the second reset driving circuit 032 may be located on a same side of the both sides; and a plurality of cascaded light-emitting driving units EM GOA included in the light-emitting driving circuit 02 may be located on a same side of the both sides.

Exemplary, on the basis of being evenly distributed on both sides of the plurality of rows of pixels in the first direction X according to every three as a group, as shown in FIG. 11, a plurality of cascaded reset driving units ResetP GOA included in the first reset driving circuit 031 and a plurality of cascaded reset driving units ResetH GOA included in the second reset driving circuit 032 may both be located on the first side of the both sides. The plurality of cascaded scan driving units NGate GOA included in the second scan driving circuit 012 and the plurality of cascaded light-emitting driving units EM GOA included in the light-emitting driving circuit 02 may both be located on the second side of the both sides.

In addition, as shown in FIG. 11, in the first direction X and along a direction close to the display region, the second reset driving circuit 032 (i.e., ResetH GOA), the first reset driving circuit 031 (i.e., ResetP GOA) and one first scan driving circuit 011 (i.e., PGate GOA) may be sequentially arranged on the first side. The second scan driving circuit 012 (i.e., NGate GOA), the light-emitting driving circuit 02 (i.e., EM GOA) and the other first scan driving circuit 011 (i.e., PGate GOA) may be sequentially arranged on the second side.

That is, the first reset driving circuit 031 including the plurality of cascaded reset driving units ResetP GOA, the second reset driving circuit 032 including the plurality of cascaded reset driving units ResetH GOA and one first scan driving circuit 011 including the plurality of cascaded scan driving units PGate GOA may be classified as one group, and located on the first side of the both sides. The second scan driving circuit 012 including the plurality of cascaded scan driving units, the scan driving circuit 032 including the plurality of cascaded light-emitting driving units EM GOA and the other first scan driving circuit 011 including the plurality of cascaded scan driving units PGate GOA may be classified as one group, and located on the second side of the both sides.

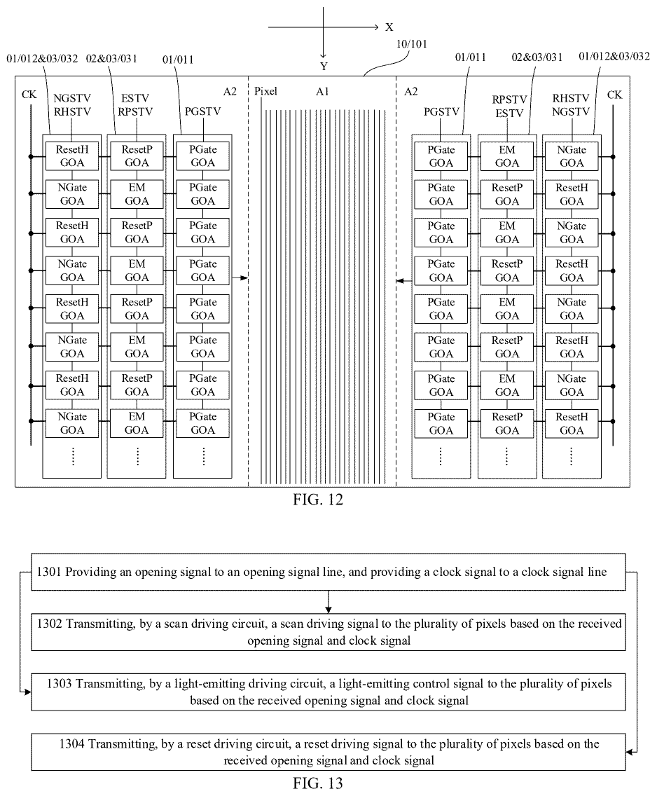

Based on FIG. 11, referring to FIG. 12, as another optional implementation:
a plurality of cascaded scan driving units PGate GOA included in the second scan driving circuit 012 may be located on a first side and a second side of both sides, respectively. A plurality of cascaded reset driving units ResetP GOA included in the first reset driving circuit 031 may be located on the first side and the second side of both sides, respectively. A plurality of cascaded reset driving units ResetH GOA included in the second reset driving circuit 032 may be located on the first side and the second side of the both sides, respectively. A plurality of cascaded light-emitting driving units EM GOA included in the light-emitting driving circuit 02 may be located on the first side and the second side of the both sides, respectively.

Exemplarily, on the basis of being evenly distributed on both sides of a plurality of rows of pixels in the first direction X according to every three as a group, as shown in FIG. 11, among the plurality of cascaded scan driving units NGate GOA included in the second scan driving circuit 012, every two adjacent scan driving units NGate GOA are located on the first side and the second side, respectively. Among the plurality of reset driving units ResetP GOA included in the first reset driving circuit 031, every two adjacent reset driving units ResetP GOA are located on the first side and the second side, respectively. Among the plurality of cascaded reset driving units ResetH GOA included in the second reset driving circuit 032, every two adjacent reset driving units ResetH GOA are located on the first side and the second side, respectively. Among the plurality of cascaded light-emitting driving units EM GOA included in the light-emitting driving circuit 02, every two adjacent light-emitting driving units EM GOA are located on the first side and the second side, respectively.

In addition, along a second direction Y of a plurality of columns of pixels, the reset driving units ResetH GOA included in the second reset driving circuit 032 and the scan driving units NGate GOA included in the second scan driving circuit 012 may be arranged alternately on the first side and the second side. The reset driving units ResetP GOA included in the first reset driving circuit 031 and the light-emitting driving units EM GOA included in the light-emitting driving circuit 012 may be arranged alternately. Correspondingly, the second direction Y may also refer to a column direction. The second direction Y and the first direction X may be intersected. For example, referring to FIG. 11 and FIG. 12, the second direction Y and the first direction X are perpendicular to each other.

That is, based on FIG. 11, a plurality of cascaded light-emitting driving units EM GOA included in the light-emitting driving circuit 02 and a plurality of reset driving units ResetP GOA included in the first reset driving circuit 031 may be arranged alternately from left to right; and a plurality of cascaded reset driving units ResetH GOA included in the second reset driving circuit 032 and a plurality of cascaded scan driving units NGate GOA included in the second scan driving circuit 012 may be arranged alternately from left to right. In this way, the plurality of light-emitting driving units EM GOA included in the light-emitting driving circuit 02, the plurality of reset driving units ResetP GOA included in the first reset driving circuit 031, the plurality of reset driving units ResetH GOA included in the second reset driving circuit 032 and the plurality of scan driving units NGate GOA included in the second scan driving circuit 012 can all transmit required signals to the pixels respectively from left and right sides in the same way as the plurality of scan driving units PGate GOA included in the first scan driving circuit 011. Further, compared with the required signals transmitted to the pixels from one side, the signals transmitted to the pixels at different positions due to the influence of Loading can be avoided, and a better display uniformity of the display panel can be further ensured.

It should be noted that the above layout design is only a schematic description. For example, for the driving units included in different driving circuits, the above embodiments are illustrated by coupling one driving unit with a row of pixels to carry out a one-to-one transmission signal. However, in some embodiments, a one-to-multiple design may also be designed. That is, one driving unit may be coupled with a plurality of rows of pixels, and meanwhile required signals (i.e., light-emitting control signals) are transmitted to the plurality of rows of pixels.

Based on the above embodiments, it can be seen that the display driving circuit described in the present embodiment of the present disclosure has the following advantages: firstly, an area of the border required to be occupied can be reduced, which is conducive to a narrow border design of the display apparatus; and secondly, the problem of signal waveform disorder can be solved, and the output stability and reliability are good, thereby ensuring that the display effect of the display panel can be better.

In summary, an embodiment of the present disclosure provides a display driving circuit. The display driving circuit includes a scan driving circuit, a light-emitting driving circuit and a reset driving circuit. A plurality of cascaded scan driving units in the scan driving circuit are coupled with a clock signal line and an opening signal line respectively, and transmit scan driving signals to pixels based on signals provided by the coupled signal lines; a plurality of cascaded light-emitting driving units in the light-emitting driving circuit are coupled with the clock signal line and the opening signal line respectively, and transmit light-emitting control signals to the pixels based on the signals provided by the coupled signal lines; and a plurality of cascaded reset driving units in the reset driving circuit are coupled with the clock signal line and the opening signal line respectively, and transmit reset control signals to the pixels based on the signals provided by the coupled signal lines so as to drive the pixels to emit light. In addition, the scan driving circuits, the light-emitting driving circuits and the reset driving circuits which provide different signals to the pixels share one clock signal line, which may facilitate a narrow border design.

FIG. 13 is a flowchart of a display driving method provided in an embodiment of the present disclosure, which can be applied to the display driving circuit as described in the above embodiments, and can be used to drive a display panel to perform a displaying operation. The display panel includes a plurality of pixels. As shown in FIG. 13, the method includes the following steps:
step 1301: providing an opening signal to an opening signal line, and providing a clock signal to a clock signal line;
step 1302: transmitting, by a scan driving circuit, a scan driving signal to the plurality of pixels based on the received opening signal and clock signal;
step 1303: transmitting, by a light-emitting driving circuit, a light-emitting control signal to the plurality of pixels based on received opening signal and clock signal; and
step 1304: transmitting, by a reset driving circuit, a reset control signal to the plurality of pixels based on received opening signal and clock signal.

The scan driving signal, the light-emitting control signal and the reset control signal can be configured to drive the plurality of pixels to emit light, so that the display panel performs a displaying operation.

Because the driving method may have basically the same implementation and technical effect as the display driving circuit described in the previous embodiments, for the purpose of conciseness, the implementation and technical effect of the driving method are not repeatedly described here.

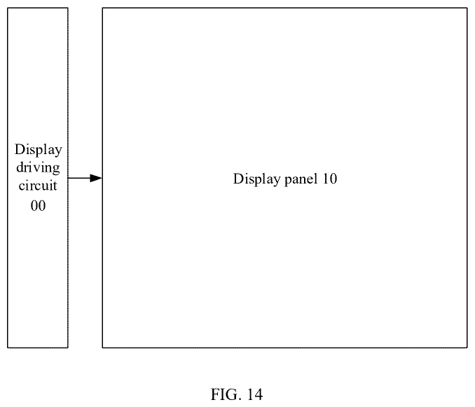

FIG. 14 is a schematic structural diagram of a display apparatus according to an embodiment of the present disclosure. As shown in FIG. 14, the display apparatus includes a display panel 10, and the display driving circuit 00 as described in the above embodiments.

The display driving circuit 00 is coupled with the plurality of pixels in the display panel 10 and configured to drive the plurality of pixels to emit light.

Optionally, the display apparatus may be an organic light-emitting diode (OLED) display apparatus, an active-matrix organic light-emitting diode (AMOLED) display apparatus, and any product or component having a display function.

Because the display apparatus may have basically the same technical effect as the display driving circuit described in the previous embodiments, for the purpose of conciseness, the implementation and technical effect of the display apparatus are not repeatedly described here.

It should be noted that the terms used in the embodiments of the present disclosure are for the purpose of explaining the embodiments only and are not intended to limit the present disclosure. The technical and scientific terms as used in the implementations of the present disclosure should have the meanings as commonly understood by a person of ordinary skill in the art of the present disclosure, unless otherwise defined.

For example, the words “first”, “second”, “third” and similar terms used in the description and claims of the present disclosure do not denote any order, quantity, or importance or are merely used to distinguish different components.

When an element is described as being “connected” or “coupled” to another element, the described element may be directly connected or coupled with the other element, or an intermediate element may be arranged between the described element and the other element. Further, the “connected” or “coupled” used herein may include wireless connection or wireless coupling.

Similarly, words such as “a” or “one” do not denote a quantitative limit, but rather the existence of at least one.

The word “include”, “comprise” or similar terms mean that elements or objects appearing before the term “include” or “comprise” cover the listed elements or objects and its equivalents appearing after the term “include” or “comprise”, while other elements or objects are not excluded.

“Upper”, “lower”, “left”, “right” and the like are only used to indicate the relative positional relationship, and when the absolute position of a described object changes, the relative positional relationship may also change accordingly.

The foregoing descriptions are merely optional embodiments of the present disclosure, and are not intended to limit the present disclosure. Within the spirit and principles of the present disclosure, any modifications, equivalent substitutions, improvements, etc., should be within the protection scope of the present disclosure.

1. A display driving circuit for a display panel comprising a plurality of pixels, wherein the display driving circuit comprises:
a scan driving circuit, wherein the scan driving circuit comprises a plurality of cascaded scan driving units which are coupled with a clock signal line, an opening signal line as well as the plurality of pixels respectively, and are configured to transmit a scan driving signal to the plurality of pixels in response to a clock signal provided by the clock signal line and an opening signal provided by the opening signal line;
a light-emitting driving circuit, wherein the light-emitting driving circuit comprises a plurality of cascaded light-emitting driving units which are coupled with a clock signal line, an opening signal line as well as the plurality of pixels respectively, and are configured to transmit a light-emitting control signal to the plurality of pixels in response to a clock signal provided by the clock signal line and an opening signal provided by the opening signal line; and
a reset driving circuit, wherein the reset driving circuit comprises a plurality of cascaded reset driving units which are coupled with a clock signal line, an opening signal line as well as the plurality of pixels respectively, and are configured to transmit a reset driving signal to the plurality of pixels in response to a clock signal provided by the clock signal line and an opening signal provided by the opening signal line, wherein
the clock signal line coupled with the plurality of scan driving units, the clock signal line coupled with the plurality of light-emitting driving units and the clock signal line coupled with the plurality of reset driving units are shared; and the opening signal line coupled with the plurality of scan driving units, the opening signal line coupled with the plurality of light-emitting driving units and the opening signal line coupled with the plurality of reset driving units are independent of each other.

2. The display driving circuit according to claim 1, wherein at least one driving unit among the scan driving unit, the light-emitting driving unit and the reset driving unit comprises:
a first gate circuit, which is respectively coupled with the opening signal line, the clock signal line, a first power line, a second power line and an output node, and is configured to control on-off of the first power line with the output node and control on-off of the second power line with the output node in response to the clock signal and the opening signal; and
a second gate circuit, which is respectively coupled with the output node, the first power line, the second power line and an output end, and is configured to control on-off of the first power line with the output end and control on-off of the second power line with the output end in response to a potential of the output node, and
wherein output ends of the plurality of scan driving units are coupled with the plurality of pixels through a plurality of scan lines, output ends of the plurality of light-emitting driving units are coupled with the plurality of pixels through a plurality of light-emitting control lines, and output ends of the plurality of reset driving units are coupled with the plurality of pixels through a plurality of reset control lines.

3. The display driving circuit according to claim 2, wherein the output node comprises a first output node and a second output node; and the first gate circuit comprises:
a first portion, which is respectively coupled with the opening signal line, the first power line, the second power line and an input node, and is configured to control on-off of the first power line with the input node and control on-off of the second power line with the input node in response to the opening signal so as to transmit an inversed opening signal, which is obtained by an inverse processing of the opening signal, to the input node; and
a second portion, which is respectively coupled with the opening signal line, the clock signal line, the first power line, the second power line, the input node, the first output node and the second output node, and is configured to control on-off of the first power line with the first output node and control on-off of the second power line with the first output node in response to the opening signal and the clock signal; and control on-off of the first power line with the second output node and control on-off of the second power line with the second output node in response to the inversed opening signal and the clock signal.

4. The display driving circuit according to claim 3, wherein the at least one driving unit further comprises:
a third gate circuit, which is connected in series between a target signal line and the second portion, also respectively coupled with the first power line and the second power line and is configured to control on-off of the first power line with the second portion and control on-off of the second power line with the second portion in response to a target signal provided by the target signal line, and
wherein the target signal line comprises at least one of the clock signal line and the opening signal line.

5. The display driving circuit according to claim 4, wherein the target signal line comprises the clock signal line and the opening signal line.

6. The display driving circuit according to claim 4, wherein the third gate circuit comprises at least one first logic gate, and
wherein a control end of the at least one first logic gate is coupled with the target signal line, input ends of the at least one first logic gate are coupled with the first power line and the second power line respectively, and an output end of the at least one first logic gate is coupled with the second portion.

7. The display driving circuit according to claim 6, wherein the at least one first logic gate comprises a transmission gate.

8. The display driving circuit according to claim 6, wherein the at least one first logic gate comprises an even number of first NOT gates which are connected in series.

9. The display driving circuit according to claim 8, wherein the at least one first logic gate comprises two first NOT gates which are connected in series.

10. The display driving circuit according to claim 3, wherein the first portion in the first gate circuit comprises a second logic gate; the second portion in the first gate circuit comprises a third logic gate and a fourth logic gate; the second gate circuit comprises a fifth logic gate and a sixth logic gate;
a control end of the second logic gate is coupled with the opening signal line, input ends of the second logic gate are coupled with the first power line and the second power line respectively, and an output end of the second logic gate is coupled with the input node;
control ends of the third logic gate are coupled with the opening signal line and the clock signal line respectively, input ends of the third logic gate are coupled with the first power line and the second power line respectively, and an output end of the third logic gate is coupled with the first output node;
control ends of the fourth logic gate are coupled with the clock signal line and the input node respectively, input ends of the fourth logic gate are coupled with the first power line and the second power line respectively, and an output end of the fourth logic gate is coupled with the second output node;
control ends of the fifth logic gate are coupled with the first output node and an output end of the sixth logic gate respectively, and input ends of the fifth logic gate are coupled with the first power line and the second power line respectively; and
control ends of the sixth logic gate are coupled with the second output node and an output end of the fifth logic gate respectively, input ends of the sixth logic gate are coupled with the first power line and the second power line respectively, and an output end of the fifth logic gate is coupled with the plurality of pixels as an output end of the second gate circuit.

11. The display driving circuit according to claim 10, wherein the second logic gate comprises a second NOT gate, and each of the third logic gate, the fourth logic gate, the fifth logic gate and the sixth logic gate comprises an NAND gate.

12. The display driving circuit according to claim 4, wherein a logic gate comprised in at least one gate circuit among the first gate circuit, the second gate circuit and the third gate circuit comprises at least one P-type transistor and at least one N-type transistor.

13. The display driving circuit according to claim 12, wherein a material of the P-type transistor comprises a low temperature poly-silicon material; and a material of the N-type transistor comprises an oxide material.

14. The display driving circuit according to claim 1, wherein the display panel further comprises a substrate having a display region and a non-display region at least partially surrounding the display region, and the plurality of pixels are located in the display region and arranged in arrays;
the scan driving circuit comprises a first scan driving circuit and a second scan driving circuit, and the reset driving circuit comprises a first reset driving circuit and a second reset driving circuit;
an opening signal line coupled with the first scan driving circuit and an opening signal line coupled with the second scan driving circuit are independent of each other, and an opening signal line coupled with the first reset driving circuit and an opening signal line coupled with the second reset driving circuit are independent of each other;
a potential of an effective level of a scan driving signal transmitted by a scan driving unit in the first scan driving circuit is opposite to a potential of an effective level of a scan driving signal transmitted by a scan driving unit in the second scan driving circuit; a potential of an effective level of a reset control signal transmitted by a reset driving unit in the first reset driving circuit is opposite to a potential of an effective level of a reset control signal transmitted by a reset driving unit in the second reset driving circuit; and
the display driving circuit is located in the non-display region; and the first scan driving circuit, the second scan driving circuit, the first reset driving circuit, the second reset driving circuit and the light-emitting driving circuit comprised in the display driving circuit are distributed on both sides of a plurality of rows of pixels in a first direction.

15. The display driving circuit according to claim 14, wherein a potential of the scan driving signal transmitted by the scan driving unit in the first scan driving circuit is smaller than a potential of the scan driving signal transmitted by the scan driving unit in the second scan driving circuit, and the scan driving circuit comprises two first scan driving circuits; and
the two first scan driving circuits, the second scan driving circuit, the first reset driving circuit, the second reset driving circuit and the light-emitting driving circuit are uniformly distributed on both sides in the first direction according to every three as a group.

16. The display driving circuit according to claim 15, wherein a plurality of cascaded scan driving units comprised in one of the two first scan driving circuits are located on a first side of the both sides; and a plurality of cascaded scan driving units comprised in the other first scan driving circuit are located on a second side of the both sides;
a plurality of cascaded scan driving units comprised in the second scan driving circuit are located on a same side of the both sides, or on the first side and the second side of the both sides, respectively;
a plurality of cascaded reset driving units comprised in the first reset driving circuit are located on a same side of the both sides, or on the first side and the second side of the both sides, respectively;
a plurality of cascaded reset driving units comprised in the second reset driving circuit are located on a same side of the both sides, or on the first side and the second side of the both sides, respectively; and
a plurality of cascaded light-emitting driving units comprised in the light-emitting driving circuit are located on a same side of the both sides, or on the first side and the second side of the both sides, respectively.

17. The display driving circuit according to claim 16, wherein the plurality of cascaded scan driving units comprised in the second scan driving circuit are located on a same side of the both sides; the plurality of cascaded reset driving units comprised in the first reset driving circuit are located on a same side of the both sides; the plurality of cascaded reset driving units comprised in the second reset driving circuit are located on a same side of the both sides; the plurality of cascaded light-emitting driving units comprised in the light-emitting driving circuit are located on a same side of the both sides;
the plurality of cascaded reset driving units comprised in the first reset driving circuit and the plurality of cascaded reset driving units comprised in the second reset driving circuit are both located on a same side of the both sides;
the plurality of cascaded scan driving units comprised in the second scan driving circuit and the plurality of cascaded light-emitting driving units comprised in the light-emitting driving circuit are both located on the second side of the both sides; and
in the first direction and along a direction close to the display region, the second reset driving circuit, the first reset driving circuit and one first scan driving circuit are arranged on the first side in sequence; and the second scan driving circuit, the light-emitting driving circuit and the other first scan driving circuit are arranged on the second side in sequence.

18. The display driving circuit according to claim 16, wherein the plurality of cascaded scan driving units comprised in the second scan driving circuit are located on the first side and the second side of the both sides; the plurality of cascaded reset driving units comprised in the first reset driving circuit are located on the first side and the second side of the both sides; the plurality of cascaded reset driving units comprised in the second reset driving circuit are located on the first side and the second side of the both sides; the plurality of cascaded light-emitting driving units comprised in the light-emitting driving circuit are located on the first side and the second side of the both sides;
among the plurality of cascaded scan driving units comprised in the second scan driving circuit, every two adjacent scan driving units are located on the first side and the second side, respectively;
among the plurality of reset driving units comprised in the first reset driving circuit, every two adjacent reset driving units are located on the first side and the second side, respectively;
among the plurality of cascaded reset driving units comprised in the second reset driving circuit, every two adjacent reset driving units are located on the first side and the second side, respectively;
among the plurality of cascaded light-emitting driving units comprised in the light-emitting driving circuit, every two adjacent light-emitting driving units are located on the first side and the second side, respectively; and
along a second direction of a plurality of columns of pixels, on the first side and the second side, the reset driving units comprised in the second reset driving circuit and the scan driving units comprised in the second scan driving circuit are alternately arranged; the reset driving units comprised in the first reset driving circuit and the light-emitting driving units comprised in the light-emitting driving circuit are alternately arranged; and the second direction and the first direction are intersected.

19. A display driving method for the display driving circuit according to claim 1 and is configured to drive a display panel to display, wherein the display panel comprises a plurality of pixels; and the method comprises:
providing an opening signal to an opening signal line, and providing a clock signal to a clock signal line;
transmitting, by a scan driving circuit, a scan driving signal to the plurality of pixels based on received opening signal and clock signal;
transmitting, by a light-emitting driving circuit, a light-emitting control signal to the plurality of pixels based on the received opening signal and clock signal; and
transmitting, by a reset driving circuit, a reset control signal to the plurality of pixels based on the received opening signal and clock signal, wherein
the scan driving signal, the light-emitting control signal and the reset control signal are configured to drive the plurality of pixels to emit light, so that the display panel performs a displaying operation.

20. A display apparatus, the display apparatus comprising a display panel, and the display driving circuit according to claim 1, wherein
the display driving circuit is coupled with the plurality of pixels in the display panel and configured to drive the plurality of pixels to emit light.
